(19) United States
(12) Patent Application Publication
(10) Pub. No.: US 2021/0185445 A1
(43) Pub. Date: Jun. 17, 2021

(54) Method for Balancing Audio Channels Using UWB Geolocation

(71) Applicant: SAGEMCOM BROADBAND SAS, Rueil Malmaison (FR)

(72) Inventors: Pierre SABATIER, RUEIL MALMAISON (FR); Gilles BOURGOIN, RUEIL MALMAISON (FR)

(21) Appl. No.: 17/125,288

(22) Filed: Dec. 17, 2020

(30) Foreign Application Priority Data
Dec. 17, 2019 (FR) 1914657

(51) Int. Cl. H04R 5/04; H04B 1/7163; H04B 17/21

(52) U.S. Cl. CPC H04R 5/04; H04B 1/7163; H04R 2205/024; H04B 2201/71634; H04B 17/21

(57) ABSTRACT

A method for balancing audio channels includes an acquisition phase comprising the step of acquiring calibration gains making it possible to balance the audio channels in a calibration position. The balancing method further includes an operational phase comprising the steps, performed in real time, of: implementing UWB geolocation to define a current position (COUR) of a mobile apparatus comprising a UWB communication component; for each audio channel, producing an operational gain which is dependent on the current position (COUR) of the mobile apparatus, on the calibration position and on the calibration gain that is associated with said audio channel, the operational gains making it possible to balance the audio channels in the current position; applying, to each audio channel, the operational gain associated with said audio channel.

The invention relates to the field of balancing audio channels of an audio broadcast system.

### BACKGROUND OF THE INVENTION

The designers of audio broadcast systems are always seeking to improve the quality of the sound signals emitted by their audio broadcast systems, and therefore the users' sound experience.

To that end, designers of course endeavour, when designing and manufacturing these audio broadcast systems, to improve the intrinsic acoustic qualities of their audio broadcast systems.

Designers also endeavour to have the audio broadcast system better take into account the environment in which it is located and the user's sound experience.

Thus, some modern connected enclosures incorporate audio processing processors which optimize the audio broadcast according to the acoustics of their environment. Each of these connected enclosures comprises an array of microphones incorporated into the connected enclosure. The connected enclosure emits acoustic test signals, uses the array of microphones to acquire resulting signals arising from reflections of said acoustic test signals, and uses the resulting signals to define the environment of the connected enclosure. The connected enclosure then adapts certain settings to this environment in order to optimize the audio broadcast.

Some multichannel amplifiers, used for example in home-cinema setups, allow the user to manually adjust the levels of the various audio channels by using a remote control. The sound rendition is very good, but this manual adjustment is carried out through menus that are very complex to operate, in particular for a user who is not familiar with this type of technology. Additionally, these adjustments are no longer valid when the user changes position.

### OBJECT OF THE INVENTION

The object of the invention is to optimize the audio broadcast and the sound experience provided by an audio broadcast system, without this optimization requiring complex operations for the user.

### SUMMARY OF THE INVENTION

With a view to achieving this object, what is proposed is a method for balancing a plurality of audio channels each comprising a speaker, the balancing method comprising an acquisition phase comprising the step of acquiring a calibration gain for each audio channel, the calibration gains having been defined in a calibration phase in a calibration position, the calibration gains making it possible to balance the audio channels in the calibration position;

the balancing method further comprising an operational phase comprising the steps, performed in real time, of:
implementing ultra-wideband (UWB) geolocation by using UWB anchors to define a current position of a mobile apparatus comprising a UWB communication component;
for each audio channel, producing an operational gain which is dependent on the current position of the mobile apparatus, on the calibration position and on the calibration gain that is associated with said audio channel, the operational gains making it possible to balance the audio channels in the current position;
applying, to each audio channel, the operational gain associated with said audio channel.

The balancing method according to the invention therefore detects, in real time, the current position of the mobile apparatus and therefore of the user in possession of the mobile apparatus, and balances the audio channels according to the current position. Thus, whatever the position of the user, the audio channels are balanced in real time and automatically, such that the user does not have to make any adjustments in order to obtain this optimized audio broadcast.

Also proposed is a balancing method such as described above in which the speakers are incorporated into enclosures, and in which the UWB anchors are incorporated into said enclosures.

Also proposed is a balancing method such as described above, in which the calibration phase uses the mobile apparatus comprising a microphone or a test apparatus comprising a microphone, and comprises the steps of:
when the mobile apparatus or the test apparatus is located in the calibration position, controlling the emission, via each of the audio channels in succession, of an emitted calibration acoustic signal, and, for each audio channel:
acquiring, by using the microphone of the mobile apparatus or of the test apparatus, a received calibration acoustic signal resulting from the emission of the emitted calibration acoustic signal via said audio channel;
defining the calibration gain on the basis of at least one characteristic of the received calibration acoustic signal.

Also proposed is a balancing method such as described above, in which the acquisition phase further comprises the step of acquiring, for each audio channel, a calibration distance between the calibration position and an enclosure incorporating the speaker of said audio channel, and wherein the operational phase further comprises the steps of:
estimating, for each audio channel, an operational distance between the mobile apparatus and the enclosure incorporating the speaker of said audio channel;
defining, for said audio channel, the operational gain according to the calibration distance, to the operational distance and to the calibration gain that are associated with said audio channel.

Also proposed is a balancing method such as described above, in which the speaker of an audio channel i is incorporated into an omnidirectional enclosure, and wherein the operational gain of said audio channel i is such that: Gₒₚᵢ=G_{cali}+20*Log 10 (Dₒₚᵢ/D_{cali}), where G_{cali} is the calibration gain (in dB), D_{cali} is the calibration distance and Dₒₚᵢ is the operational distance that are associated with said audio channel.

Also proposed is a balancing method such as described above, in which the speaker of an audio channel is incorporated into a directional enclosure, wherein a UWB anchor comprising two UWB antennas is incorporated into said directional enclosure such that the UWB antennas are positioned on either side of an axis of symmetry of a directivity diagram of the directional enclosure, wherein the acquisition phase comprises the step of acquiring a calibration angle between the axis of symmetry and a calibration direction passing through the calibration position and through the directional enclosure, wherein the operational phase comprises the step of estimating an operational angle between the axis of symmetry and an operational direction passing through the current position and through the directional enclosure, and wherein the operational gain associated with said audio channel is estimated by using the calibration angle and the operational angle.

Also proposed is a balancing method such as described above, in which the operational gain of said audio channel i is defined by:

Gₒₚᵢ=G_{cali}−20*Log 10(P(Θₒₚᵢ)/P(Θ_{cali}))+20*Log 10(Dₒₚᵢ/D_{cali}),

where, for said audio channel i, G_{cali} is the calibration gain (in dB), D_{cali} is the calibration distance, Dₒₚᵢ is the operational distance, P(Θₒₚᵢ) is an emission sound pressure level of the enclosure in the operational direction and P(Θ_{cali}) is an emission sound pressure level of the enclosure in the calibration direction.

Also proposed is a balancing method such as described above, in which an enclosure incorporating the speaker of an audio channel comprises no UWB anchor, the calibration phase further comprising the steps of positioning the mobile apparatus in a close position in proximity to said enclosure, of implementing UWB geolocation in order to determine the close position, of equating the actual position of the enclosure to the close position, the estimate of the calibration distance and the estimate of the operational distance that are associated with said audio channel being produced by using the actual position of the enclosure.

Also proposed is a balancing method such as described above, in which the operational gains are updated only when the mobile apparatus has experienced a movement greater than a predetermined threshold with respect to its preceding current position.

Also proposed is a balancing method such as described above, in which the acquisition phase comprises the step of acquiring a phase difference in order to produce an immersive sound in the calibration position, and wherein the operational phase comprises the step of calculating, according to the current position, a delay applied to the immersive sound.

Also proposed is a balancing method such as described above, in which the calibration gains and/or the emission sound pressure levels of the enclosures in the calibration directions, which are used in the operational phase to define the operational gains, are dependent on a frequency of an acoustic signal broadcast in the operational phase by the audio channels.

Further proposed is an apparatus comprising a processing component in which the balancing method described above is implemented.

Further proposed is an apparatus such as that described above, the apparatus being a smartphone.

Further proposed is an apparatus such as that described above, the apparatus being a connected enclosure.

Further proposed is a computer program comprising instructions which result in the apparatus such as that described above executing the steps of the balancing method described above.

Further proposed is a computer-readable storage medium, on which the computer program described above is stored.

The invention will be better understood in the light of the following description of particular non-limiting implementations of the invention.

### BRIEF DESCRIPTION OF THE DRAWINGS

Reference will be made to the following drawings, in which:

FIG. 1 shows a dwelling in which a smartphone and enclosures each incorporating a UWB anchor are present;

FIG. 2 shows components of the smartphone;

FIG. 3 shows components of an enclosure;

FIG. 4 shows UWB anchors and the smartphone when UWB geolocation is implemented in the balancing method according to the invention;

FIG. 5 shows the enclosures, the smartphone, the calibration distances and the operational distances when the balancing method according to a first embodiment of the invention is implemented;

FIG. 6 shows steps of a calibration phase of the balancing method;

FIG. 7 shows steps of an operational phase of the balancing method;

FIG. 8 shows enclosures, UWB anchors and the smartphone when UWB geolocation is implemented in a balancing method according to a second embodiment of the invention;

FIG. 9 shows an enclosure and two UWB antennas of a UWB anchor;

FIG. 10 illustrates a method for determining an angle of arrival of a UWB signal;

FIG. 11 shows a user in the calibration position and the enclosure de FIG. 9;

FIG. 12 shows steps of a calibration phase of a balancing method according to a third embodiment of the invention;

FIG. 13 shows steps of an operational phase of the balancing method.

### DETAILED DESCRIPTION OF THE INVENTION

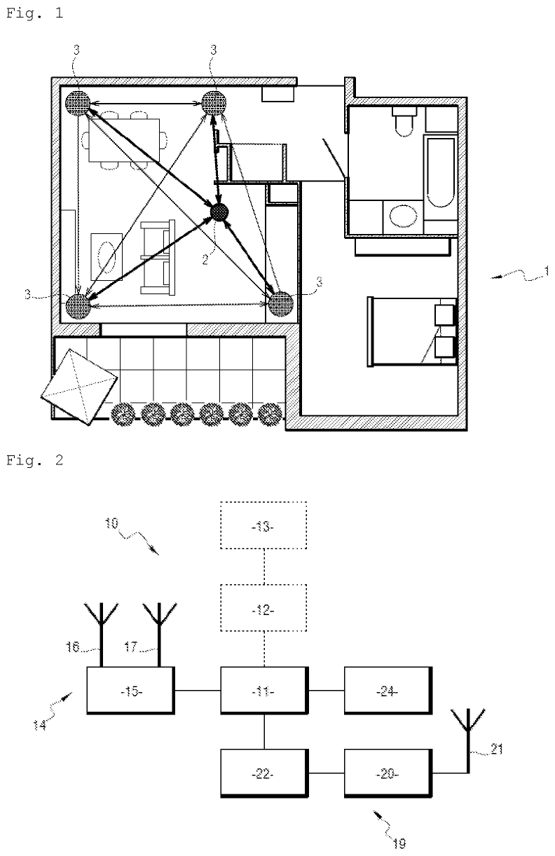

With reference to FIG. 1, the balancing method according to the invention is intended to balance, in real time, according to the current position of a mobile apparatus 1 carried by a user, the audio channels of an audio broadcast system located for example in a dwelling 2.

Each audio channel comprises a speaker incorporated into a connected enclosure 3.

In this description, the mobile apparatus 1 is a smartphone.

The smartphone comprises or is connected to a UWB (for ultra-wideband) geolocation device.

The current position of the smartphone is determined via UWB geolocation. This UWB geolocation is relatively precise (of the order of a centimetre). For this, the UWB geolocation device of the smartphone cooperates with UWB anchors which are possibly, but not necessarily, incorporated into the enclosures.

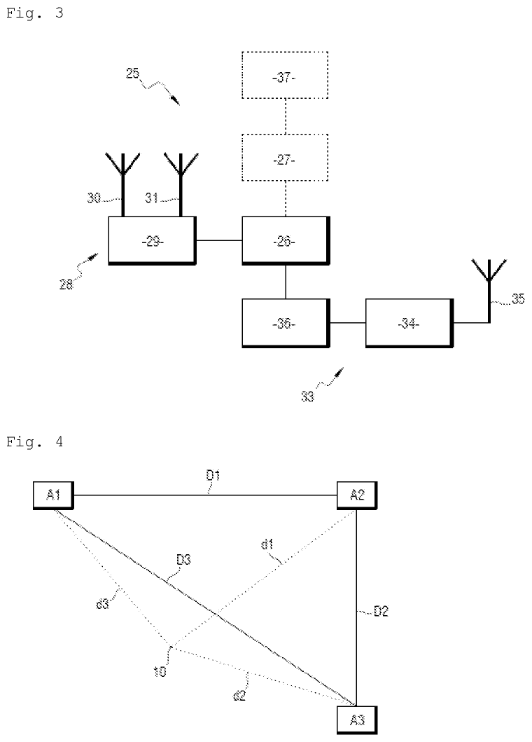

With reference to FIG. 2, the smartphone 10 firstly comprises a central processor 11 which is controlled by an operating system 12.

The central processor 11 is capable of executing instructions of an application 13 for implementing the balancing method according to the invention.

The smartphone 10 further comprises a communication device, which is a (native) Wi-Fi communication interface 14 comprising a Wi-Fi communication component 15, a first antenna 16 and a second antenna 17. The Wi-Fi communication component 15 comprises a 2.4 GHz channel connected to the first antenna 16 and a 5 GHz channel connected to the second antenna 17.

The smartphone 10 further comprises a geolocation device 19. The geolocation device 19 is arranged so as to implement UWB geolocation of the smartphone 10.

The geolocation device 19 is here implemented natively in the smartphone 10. The geolocation device 19 comprises a communication component 20, an antenna 21 and a microcontroller 22. The microcontroller 22 is connected to the central processor 11 via a wired (for example I2C, serial, etc.) or wireless (for example Bluetooth) interface.

Alternatively, the geolocation device could comprise a UWB tag. The UWB tag would then be positioned as close as possible to the smartphone, or even incorporated into the smartphone.

The smartphone 10 also comprises a microphone 24.

With reference to FIG. 3, each enclosure 25 comprises at least one speaker (not shown). The enclosure 25 further comprises a central processor 26 which is controlled by an operating system 27.

The enclosure 25 further comprises a Wi-Fi communication interface 28 comprising a Wi-Fi communication component 29, a first antenna 30 and a second antenna 31. The Wi-Fi communication component 29 comprises a 2.4 GHz channel connected to the first antenna 30 and a 5 GHz channel connected to the second antenna 31.

The enclosure 25 further comprises a geolocation device 33. The geolocation device 33 comprises a UWB communication component 34, a UWB antenna 35 and a microcontroller 36. The microcontroller 36 is connected to the central processor 26 via a serial link. The microcontroller 36 dialogues with the UWB communication component 34 and provides the central processor 26 with location information. The operating system 27 allows this location information to be managed.

The central processor 26 is capable of executing instructions of software 37 for implementing the geolocation of the smartphone 10.

The operating system 27 makes the positioning information available, for example via a software interface or an API (for application programming interface). The positioning information is retrieved and then processed by an application.

Each enclosure 25 is registered when it is installed using a unique number, for example its MAC address.

The smartphone 10 communicates with the enclosures 25 by virtue of a Wi-Fi link. The enclosures 25 communicates with one another via a Wi-Fi link.

The operation of the UWB geolocation will now be described in more detail.

The geolocation devices of the enclosures form the UWB anchors.

The UWB geolocation is here based on trilateration performed on the basis of measurements of distances between various elements.

The distance between the elements taken in pairs is obtained by measuring the time of flight of a wideband pulsed radio signal which has the property of travelling in a straight line and of crossing obstacles in an environment encountered in a dwelling, or, more generally, in any building.

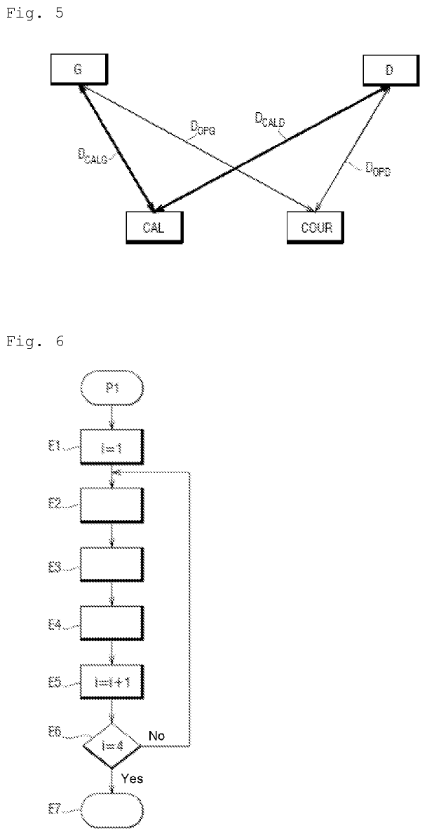

With reference to FIG. 4, by using an established network of fixed points (the UWB anchors A1, A2, A3) forming a coordinate system (which is not necessarily orthonormal), the relative positions of which are evaluated by the system on the basis of the distances separating them (distances D1, D2 & D3), the smartphone 10 is located precisely in terms of absolute position with respect to the coordinate system.

The position of the smartphone 10 is located at the intersection of the spheres centred on each UWB anchor. The radius of a sphere centred on a UWB anchor corresponds to the distance, calculated on the basis of the time of flight of the UWB signal, between the smartphone 10 and said UWB anchor.

Here, with a network of three anchors, the estimated distances from the smartphone 10 to the various anchors, i.e. d1, d2, d3, are calculated.

The acquisition of the geolocation data will now be described using an exemplary selection of components.

For example, the DECAWAVE MDEK1001 location solution is used. The UWB communication component 20 of the smartphone 10 is the DECAWAVE DW1000 component. The microcontroller 22 of the smartphone 10 is the microcontroller containing DECAWAVE firmware allowing the UWB communication component to be used. The two components communicate with one another via a serial link.

The microcontroller used throughout the remainder of the description is of NORDIC type, without the solution described being limited to this type of microcontroller. Other types of microcontrollers, such as STM32, may be used. The system may also operate without a microcontroller, by using a direct connection with the central microprocessor.

The UWB communication component is responsible for forming and transmitting the signals of the radio pulses defined by the NORDIC microcontroller, and for receiving and decoding the radiofrequency pulses received in order to extract therefrom the payload data and transmit them to the NORDIC microcontroller.

The NORDIC microcontroller is responsible for configuring and using the UWB communication component in order to generate the bursts, and decode the return bursts, thus making it possible to calculate, on the basis of the two-way time of flight, the distance between the apparatuses. It is therefore capable of directly obtaining the distances separating the UWB communication component from the other apparatuses, but also of obtaining from the other apparatuses the supplementary information on the respective distances between the other apparatuses. On the basis of the knowledge of the various distances, it is responsible for evaluating the geographical position of each apparatus with respect to a network of calibration anchors. For this, it implements a trilateration method.

The NORDIC microcontroller is also responsible for communicating with the central processor 11 of the smartphone 10 via a serial port connected through a USB link, or directly through a serial link, or even through a Bluetooth link. It is thus capable of receiving commands for performing specific actions, and of transmitting responses to the central processor 11.

The NORDIC microcontroller provides a certain number of commands that make it possible to trigger a certain number of actions, and to obtain a certain number of actions in return. It is also possible to add commands to those present, since the development environment is open, and the source code fully documented.

In its default operating mode, the NORDIC microcontroller periodically transmits, over the serial link carried by the USB link, a report on the state of the system in the form of character strings. One example of a character string corresponding to the location is the following:

{‘timestamp’: 1569763879.354127, ‘x’: 2.168, ‘y’: 0.62844, ‘type’: ‘tag’}
{‘timestamp’: 1569763879.937741, ‘type’: ‘anchor’, ‘x’: 0.0, ‘y’: 0.0}
{‘timestamp’: 1569763879.9407377, ‘type’: ‘anchor’, ‘dist’: 3.287105, ‘x’: 3.5, ‘y’: 0.0}
{‘timestamp’: 1569763879.943739, ‘type’: ‘anchor’, ‘dist’: 9.489347, ‘x’: 3.5, ‘y’: 9.0}

These data are easily decomposable. Each line corresponds to one of the apparatuses of the system (enclosure 25 or smartphone 10), and the following fields associated with a value are easily discerned there:

timestamp: date of transmission of the report by the geolocation device of the smartphone 10;

x and y: coordinates in metres of the apparatus with respect to the calibration coordinate system formed by the UWB anchors. The coordinates of the UWB anchors are returned with a precision rounded to within 0.5 m;

type: type of the apparatus: tag=smartphone, anchor=UWB anchor;

dist: distance in metres between the smartphone 10 and the calibration point UWB anchor of the system. This information does not exist for the calibration anchor.

There are therefore four apparatuses in this example.

The smartphone 10 is located at the coordinates x=2.168 m; y=0.628 m.

The calibration UWB anchor is located at the coordinates x=0 m; y=0 m.

One UWB anchor is located at the coordinates x=3.5 m; y=0 m, at a distance of 3.287 m from the calibration anchor.

One UWB anchor is located at the coordinates x=3.5 m; y=9.0 m, at a distance of 9.489 m from the calibration anchor.

This information is delivered via the USB link to the operating system 12 of the central processor 11 of the smartphone 10. It is straightforward for the embedded software in the central processor 11 to collect this information and to process it.

The implementation of the balancing method according to a first embodiment of the invention will now be described more precisely. In the first embodiment, each speaker of an audio channel is incorporated into a distinct enclosure. The enclosures are connected to an audio amplifier. The UWB anchors are incorporated into the enclosures.

It is known that sound waves propagating through the air are attenuated with the square of the distance.

The sound level (or sound pressure level) where the user is located is inversely proportional to the distance squared (−6 dB for each doubling of distance).

The balancing method firstly comprises a calibration phase, which consists in particular in measuring the sound pressure level at any location in the room.

In the calibration phase, the user with the smartphone takes a calibration position. The calibration position is any position, for example in proximity to the enclosures. The calibration position is not necessarily the usual listening position.

The calibration position is firstly determined by UWB geolocation, implemented using the smartphone and the UWB anchors incorporated into the enclosures. The coordinates of the calibration position in the coordinate system formed by the UWB anchors are thus obtained.

Next, for each audio channel, a calibration distance between the smartphone and the enclosure incorporating the speaker of said audio channel is determined on the basis of the calibration position.

Thus, in the example of FIG. 5, the audio broadcast system comprises a left-hand audio channel comprising a left-hand enclosure G and a right-hand audio channel comprising a right-hand enclosure D.

The calibration distance D_{CALG} is the distance, in the calibration position CAL, between the smartphone and the left-hand enclosure G. The calibration distance D_{CALD} is the distance, in the calibration position CAL, between the smartphone and the right-hand enclosure D.

The application implemented in the central processor (references 12 and 13 in FIG. 2) of the smartphone then retrieves the reference distances.

The smartphone then controls the emission, via each of the audio channels in succession, of an emitted calibration acoustic signal. For each audio channel, the smartphone acquires, by using its microphone, a received calibration acoustic signal resulting from the emission of the emitted calibration acoustic signal via said audio channel.

In this way, an intrinsic measurement of the sound levels is obtained via the microphone of the smartphone.

Next, for each audio channel, the smartphone defines the calibration gain associated with said audio channel on the basis of at least one characteristic of the received calibration acoustic signal. The calibration gains make it possible to balance the audio channels in the calibration position.

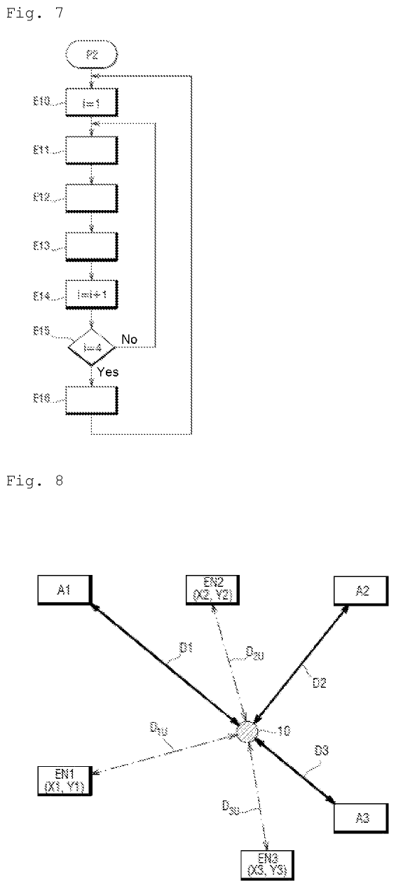

One exemplary implementation of the calibration phase can be seen in FIG. 6. In this example, the audio broadcast system comprises four audio channels: audio channels 1, 2, 3, 4.

Following the initiation of the calibration phase (P1), the variable i is set to 1:

i=1 (step E1).

Next, the calibration distance between the calibration position and the enclosure of the audio channel i (i.e. the audio channel 1) is measured by UWB geolocation (step E2).

The emitted acoustic calibration signal is sent by the enclosure of the audio channel i. The received acoustic calibration signal is acquired by the smartphone. The gain perceived by the smartphone is stored (step E4).

The variable i is incremented:

i=i+1 (step E5)

Next, in step E6, it is checked whether the variable i has reached the value corresponding to the total number of audio channels of the audio broadcast system (four here).

If this is the case, the calibration phase ends (step E7). Otherwise, the calibration phase returns to step E2.

The smartphone then balances the various sound levels by acting on the gains of the enclosures.

The smartphone thus defines, in the calibration position, a calibration gain for each audio channel, the calibration gains making it possible to balance the audio channels in the calibration position.

This balancing makes it possible to state that at one point in the room, i.e. in the calibration position, the audio channels are balanced.

Once the calibration phase has been carried out, the balancing is performed in real time, according to the current position of the user (or, more precisely, according to the current position of the smartphone).

The balancing method thus comprises an operational phase implemented in real time.

The operational phase consists in using UWB geolocation to define the current position of the smartphone and, for each audio channel, in producing an operational gain which is dependent on the current position of the smartphone, on the calibration position and on the calibration gain that are associated with said audio channel, the operational gains making it possible to balance the audio channels in the current position.

For each audio channel, on the basis of the current position, an operational distance between the smartphone and the enclosure incorporating the speaker of said audio channel is estimated. Next, for said audio channel, the operational gain is defined according to the calibration distance, to the operational distance and to the calibration gain that are associated with said audio channel.

Returning to FIG. 5, the operational distance D₀PG is the distance, in the current position COUR, between the smartphone and the left-hand enclosure G. The operational distance D₀PD is the distance, in the current position COUR, between the smartphone and the right-hand enclosure D.

The operational gain (en dB) of an audio channel i is determined by the following formula:

Gₒₚᵢ=G_{cali}+20*Log 10(Dₒₚᵢ/D_{cali}),

where G_{cali} is the calibration gain in dB, D_{cali} is the calibration distance and Dₒₚᵢ is the operational distance that are associated with said audio channel i.

An operational gain for each audio channel is thus obtained.

The operational gains are transmitted to the enclosures by the smartphone. To each audio channel, the operational gain associated with said audio channel is applied. In this way, the audio channels are balanced in the current position.

It should be noted that the operational gains are updated only when the smartphone has experienced a movement greater than a predetermined threshold with respect to its preceding current position. The predetermined threshold is for example equal to 30 cm.

In this way, a gain change noise effect during listening is avoided.

One exemplary implementation of the operational phase can be seen in FIG. 7. In this example, again, the audio broadcast system comprises four audio channels: audio channels 1, 2, 3, 4.

Following the initiation of the operational phase (P2), the variable i is set to 1:

i=1 (step E10).

Next, the operational distance between the current position of the mobile apparatus and the enclosure of the audio channel i is measured (step E11).

The operational gain Gₒₚᵢ for the audio channel i is then estimated (step E12).

The operational gain Gₒₚᵢ is then applied to the audio channel i (step E13).

The variable i is incremented:

i=i+1 (step E14)

Next, in step E15, it is checked whether the variable i has reached the value corresponding to the total number of audio channels of the audio broadcast system.

If this is not the case, the operational phase returns to step E11.

If this is the case, a time lag is applied, for example equal to 1 s. Following this time lag, which makes it possible to avoid the gain change noise effect during listening, the user has potentially changed current position and the operational phase returns to step E10, in order to rebalance the audio channels according to the new current position.

It should be noted that the time lag could be replaced with smoothing, filtering, averaging of measurements, etc.

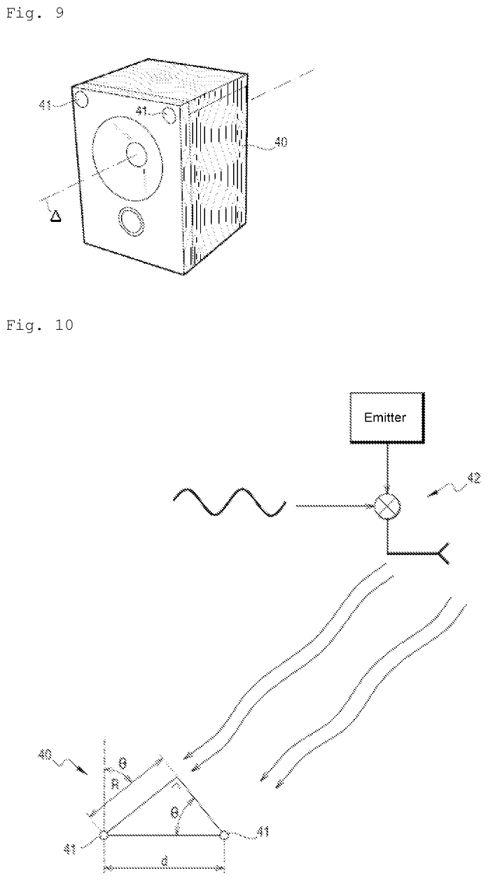

A balancing method according to a second embodiment of the invention will now be described with reference to FIG. 8.

In the example of FIG. 8, the audio broadcast system this time comprises three enclosures EN1, EN2, EN3, each of which incorporates a speaker of a distinct audio channel.

The UWB anchors A1, A2 and A3, three in number, are this time not incorporated into the enclosures.

It is therefore necessary to determine, in the calibration phase, the position of each enclosure in the frame of reference of the UWB anchors.

In the calibration phase, the application programmed into the smartphone (i.e. the application 13 of FIG. 3) asks the user to position the smartphone in a close position in proximity to each enclosure.

The smartphone implements UWB geolocation in order to determine the close position, and equates the actual position of the enclosure to the close position.

Concretely, the enclosure name is displayed on the screen of the smartphone, for example Speaker 1, Speaker 2, Speaker 3. The user positions themself vertically in line with each enclosure in succession, and presses the button corresponding to the enclosure in question.

For each audio channel, the smartphone then estimates the calibration distance and the operational distance that are associated with said audio channel by using the actual position of the enclosure.

Thus, in FIG. 8, the position of each enclosure EN1, EN2, EN3, and therefore the coordinates of each enclosure, are determined in the calibration phase.

The enclosure EN1 has the coordinates X1, Y1 in the coordinate system formed by the UWB anchors. The enclosure EN2 has the coordinates X2, Y2 in the coordinate system formed by the UWB anchors. The enclosure EN3 has the coordinates X3, Y3 in the coordinate system formed by the UWB anchors.

To determine the distance DiU between the user and the enclosure of the audio channel i, a change in coordinate system is made by calculating the Euclidean distance:

DiU=((Xu−Xi)\hat{ }2+(Yu−Yi)\hat{ }2)\hat{ }(½) for i varying from 1 to 3, Xu, Yu being the coordinates of the position of the user.

This is valid when the user is located in the calibration position and in the current position, and therefore for calculating the calibration distances and the operational distances.

It should be noted that, in FIG. 8, the number of UWB anchors is equal to three, which makes it possible to define the positions and the distances in a two-dimensional space, which is particularly suited to an apartment for example. A different number of UWB anchors is of course conceivable. For example, with four UWB anchors, it is possible to define a three-dimensional space, which makes it possible for example to manage the height in an apartment or to manage the storeys in a multistorey house.

A balancing method according to a third embodiment of the invention will now be described. This time, the enclosures are not omnidirectional enclosures but directional enclosures.

Each enclosure therefore has a directivity diagram which is measured prior to the installation of the enclosure, i.e. for example on the production line or during tests in the development of the enclosure.

The directivity diagram is dependent on the aperture of the acoustic horn of the speaker of the enclosure.

It should be noted that the enclosures may be identical or not identical, and may have the same or not the same directivity diagram.

To simplify the description, a two-dimensional space or plane is used for the reasoning in what follows. However, this description is valid in a three-dimensional space, the directivity diagram then being a three-dimensional diagram.

It is also assumed, for simplicity, that the directivity diagram is independent of the sound level.

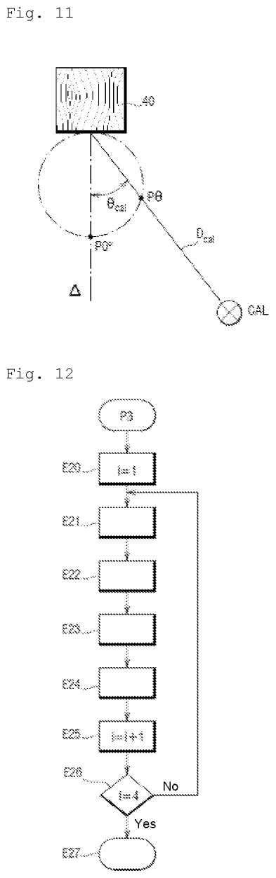

With reference to FIGS. 9 and 10, the UWB anchor of the enclosure 40 this time comprises two UWB antennas 41 which are connected to the UWB communication component of the geolocation device of the enclosure 40.

In such a configuration, it is possible to measure, at the UWB anchor, the difference in time of reception of a UWB signal coming from the smartphone 42, and to deduce an angle of arrival from this difference in time of reception.

The UWB antennas 41 are positioned on either side of an axis of symmetry Δ of the directivity diagram of the enclosure 40, equidistant from the axis of symmetry Δ and such that the axis of symmetry Δ is orthogonal to a straight line connecting the two UWB antennas 41.

Thus, it is possible to measure not only the distance between the smartphone 42 and the enclosure 40, but also the angle of arrival Θ of the UWB signal emitted by the smartphone 42. Therefore, by virtue of the knowledge of the directivity diagram, an estimate of the sound level emitted by the enclosure 40 in the relative position and relative orientation with respect to the user is obtained.

With reference to FIG. 11, the calibration phase of the balancing method therefore comprises the step of estimating a calibration angle Θ_{cal} between the axis of symmetry Δ and a calibration direction D_{cal} that passes through the calibration position CAL and through the enclosure 40.

In the position CAL, the user therefore sees the enclosure 40 at an angle Θ, the emission sound pressure level associated with this angle Θ being P(Θ) while the emission sound pressure level associated with the angle of 0°, i.e. with the direction of the axis of symmetry Δ, is P(0°).

P(0°) and P(Θ) are characteristics of the connected enclosure measured beforehand according to data from the maker of the connected enclosure.

Similarly, the operational phase comprises the step of estimating an operational angle between the axis of symmetry and an operational direction that passes through the current position and through the directional enclosure. The operational gain associated with the audio channel including the connected enclosure is estimated by using the calibration angle and the operational angle.

The directivity diagram is stored either in the memory of each of the enclosures, or in the application of the smartphone which has knowledge, in its memory, of a number of types of enclosures.

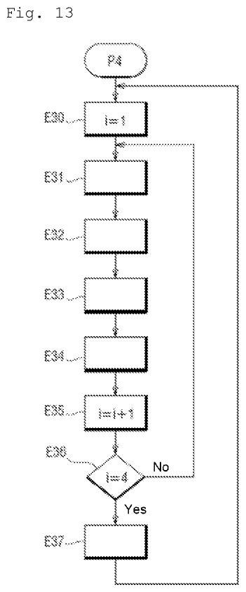

In the example of FIG. 12, the audio broadcast system comprises four audio channels: audio channels 1, 2, 3, 4.

Following the initiation of the calibration phase (P3), the variable i is set to 1:

i=1 (step E20).

In the calibration position, the calibration distance between the smartphone and the enclosure of the audio channel i is measured by UWB geolocation (step E21).

Next, the calibration angle Θ_{cali} is measured. Θ_{cali} is the angle of the user in the calibration position seen from the enclosure of the audio channel i (step E22).

The emitted acoustic calibration signal is sent by the enclosure i (step E223).

The calibration gain is measured and stored (step E24).

The variable i is incremented:

i=i+1 (step E25)

It is checked whether the variable i has reached the value corresponding to the total number of audio channels of the audio broadcast system (here equal to four: step E26).

If this is the case, the calibration phase ends (step E27). Otherwise, the calibration phase returns to step E21.

What is obtained is therefore not only an adjustment with respect to the distance between the user and the enclosures, but also the directivity being taken into account.

Next, when the user moves, an operational distance is calculated between the user and each of the enclosures as explained above. The directivity diagram of each enclosure is taken into account. Specifically, for each enclosure, the operational angle is measured in real time between the user in their current position and the enclosure in question. The operational gain sent to each enclosure takes into account the operational angle and the emission sound pressure level of the enclosure in the direction corresponding to said operational angle.

Thus, with reference to FIG. 13, upon initiation of the operational phase (P4), the variable i is set to 1:

i=1 (step E30).

The operational distance between the smartphone and the enclosure of the audio channel i is measured by UWB geolocation (step E31).

The operational angle Θₒₚ is measured. The operational angle Θₒₚᵢ is the angle of the user in the current position seen from the enclosure of the audio channel i (step E32).

The operational gain is then evaluated (step E33). The operational gain for the audio channel i is defined by:

Gₒₚᵢ=G_{cali}−20*Log 10(P(Θₒₚᵢ)/P(Θ_{cali}))+20*Log 10(Dₒₚᵢ/D_{cali}),

where, for said audio channel i, G_{cali} is the calibration gain in dB, D_{cali} is the calibration distance, Dₒₚᵢ is the operational distance, P(Θₒₚᵢ) is an emission sound pressure level of the enclosure in the operational direction and P(Θ_{cali}) is an emission sound pressure level of the enclosure in the calibration direction.

The operational gain is applied to the audio channel i (step E34).

The variable i is incremented:

i=i+1 (step E35).

It is checked whether the variable i has reached the value corresponding to the total number of audio channels of the audio broadcast system (here equal to four: step E36).

If this is not the case, the operational phase returns to step E31.

If this is the case, a time lag is applied, for example 1 s. Following this time lag, the user has potentially changed current position and the operational phase returns to step E30.

In this way, a table filled in in the following manner is obtained:

for the columns, the emission sound pressure levels are defined according to the angle Θ which varies for example from −360 to +360° in increments of 10 degrees;

for the rows, the various enclosures listed.

It would additionally be possible to stick UWB tags to enclosures not provided with a UWB anchor, preferably perpendicularly to the axis of symmetry of the directivity diagram (i.e. like in FIG. 9).

It should be noted that it would be entirely possible to have a mono-enclosure comprising a plurality of speakers each belonging to a different audio channel. In this case, what was explained above is repeated: the speakers are indeed considered as belonging to distinct audio channels, but are superposed spatially.

It is also possible to have a mono-enclosure incorporating a single channel. In this case, only the directivity diagram is unique. It is taken into account in the calibration as described above and when the user moves. The angle and distance measurements are taken. The gain of the enclosure is adjusted according to the distance and according to the directivity diagram so that the sound level perceived is identical when the user moves.

The balancing method may be implemented so as to produce an immersive sound.

The spatialized sound is then dependent on the phases of the signals.

The calibration phase therefore comprises the step of defining a phase difference in order to produce an immersive sound in the calibration position.

In the same way as above, the immersive sound is available in the calibration position in which calibration was performed.

If no action is taken, the sound is still audible when the user moves, but the immersive character is lost.

The operational phase therefore comprises the step of calculating, according to the current position of the user, a delay applied to the immersive sound.

When the user moves, the current position and the operational distances are estimated.

The times of propagation of the acoustic signals through the air are determined between each enclosure and the user according to the speed of propagation of sound though air.

The delay applied to the immersive sound is calculated so that, whatever the current position, the user has the same auditive sensation as if they were located in the calibration position.

The delay is calculated by applying the formula:

Tₚᵢ=Dₒₚᵢ/Vₛ,

where Tₚᵢ is the time of propagation of the sound between the enclosure i and the user, where Dₒₚᵢ is the operational distance between the current position of the user and the enclosure i, and where Vₛ is the speed of sound in air (approximately 340 m/s).

The delay is then applied to each of the enclosures i.

Of course, the invention is not limited to the embodiments described but encompasses all variants that fall within the scope of the invention such as defined by the claims.

The calibration phase is not necessarily implemented while the enclosures are in service, but could be carried out in the factory at the end of the manufacturing of the enclosures using a test apparatus comprising a microphone.

In this case, to implement the balancing method according to the invention, the mobile apparatus acquires the calibration parameters obtained by the test apparatus: calibration gains, calibration distances, calibration angles, emission sound pressure levels of the enclosure in the calibration direction, etc. The calibration data may be stored in the mobile apparatus, or else in a remote apparatus (enclosure, server, etc.) accessed by the mobile apparatus. It is considered that the balancing method comprises an “initial” acquisition phase that consists in acquiring the calibration data, regardless of whether or not the calibration phase was performed by the mobile apparatus.

It should be noted that the calibration parameters may have values that are dependent on the frequency, since the enclosures may have different responses depending on the frequency. The calibration gains and/or the emission sound pressure levels of the enclosures in the calibration directions, which are used in the operational phase to define the operational gains, will therefore be dependent on the frequency of the acoustic signal broadcast in the operational phase by the audio channels.

The invention may be implemented with an audio broadcast system comprising any number of audio channels.

The mobile apparatus is not necessarily a smartphone, but could be a different apparatus: tablet, connected watch, etc.

Here, it has been described that the calibration method is entirely implemented in the mobile apparatus. The calibration method could also be implemented, entirely or partially, in a fixed apparatus, for example in one of the enclosures (which would then be a “master” enclosure), in an audio amplifier or in a set-top box, or even in a remote server. The balancing method may also be performed by a plurality of these apparatuses.

In this case, the mobile apparatus transmits, to the one or more apparatuses in question, the measurements taken (position, distance, gain, angle, etc.).

It has been described that the mobile apparatus and the enclosures communicate by Wi-Fi by virtue of Wi-Fi communication interfaces. However, the communication is not limited to Wi-Fi, it being possible to use other types of wireless link instead, such as for example Bluetooth or UWB.

1. A method for balancing a plurality of audio channels each comprising a speaker, the balancing method comprising an acquisition phase comprising the step of acquiring a calibration gain for each audio channel, the calibration gains having been defined in a calibration phase in a calibration position (CAL), the calibration gains making it possible to balance the audio channels in the calibration position;
the balancing method further comprising an operational phase comprising the steps, performed in real time, of:
implementing ultra-wideband (UWB) geolocation by using UWB anchors to define a current position (COUR) of a mobile apparatus comprising a UWB communication component (20);
for each audio channel, producing an operational gain which is dependent on the current position (COUR) of the mobile apparatus, on the calibration position and on the calibration gain that is associated with said audio channel, the operational gains making it possible to balance the audio channels in the current position;
applying, to each audio channel, the operational gain associated with said audio channel.

2. The method according to claim 1, wherein the speakers are incorporated into enclosures, and wherein the UWB anchors are incorporated into said enclosures.

3. The method according to claim 1, wherein the calibration phase uses the mobile apparatus comprising a microphone or a test apparatus comprising a microphone, and comprises the steps of:
when the mobile apparatus or the test apparatus are located in the calibration position, controlling the emission, via each of the audio channels in succession, of an emitted calibration acoustic signal, and, for each audio channel:
acquiring, by using the microphone of the mobile apparatus or of the test apparatus, a received calibration acoustic signal resulting from the emission of the emitted calibration acoustic signal via said audio channel;
defining the calibration gain on the basis of at least one characteristic of the received calibration acoustic signal.

4. The method according to claim 1, wherein the acquisition phase further comprises the step of acquiring, for each audio channel, a calibration distance (D_{CALG}, D_{CALD}) between the calibration position and an enclosure (G, D) incorporating the speaker of said audio channel,
and wherein the operational phase further comprises the steps of:
estimating, for each audio channel, an operational distance (D_{OPG}, D_{OPD}) between the mobile apparatus and the enclosure incorporating the speaker of said audio channel;
defining, for said audio channel, the operational gain according to the calibration distance, to the operational distance and to the calibration gain that are associated with said audio channel.

5. The method according to claim 4, wherein the speaker of an audio channel i is incorporated into an omnidirectional enclosure, and wherein the operational gain of said audio channel i is such that:
Gₒₚᵢ=G_{cali}+20*Log 10(Dₒₚᵢ/D_{cali}), where G_{cali} is the calibration gain in dB, D_{cali} is the calibration distance and Dₒₚᵢ is the operational distance that are associated with said audio channel.

6. The method according to claim 4, wherein the speaker of an audio channel is incorporated into a directional enclosure, wherein a UWB anchor comprising two UWB antennas is incorporated into said directional enclosure such that the UWB antennas are positioned on either side of an axis of symmetry (Δ) of a directivity diagram of the directional enclosure, wherein the acquisition phase comprises the step of acquiring a calibration angle between the axis of symmetry and a calibration direction passing through the calibration position and through the directional enclosure, wherein the operational phase comprises the step of estimating an operational angle between the axis of symmetry and an operational direction passing through the current position and through the directional enclosure, and wherein the operational gain associated with said audio channel is estimated by using the calibration angle and the operational angle.

7. The method according to claim 6, wherein the operational gain of said audio channel i is defined by:
Gₒₚᵢ=G_{cali}−20*Log 10(P(Θₒₚᵢ)/P(Θ_{cali}))+20*Log 10(Dₒₚᵢ/D_{cali}),
where, for said audio channel i, G_{cali} is the calibration gain, D_{cali} is the calibration distance, Dₒₚᵢ is the operational distance, P(Θₒₚᵢ) is an emission sound pressure level of the enclosure in the operational direction and P(Θ_{cali}) is an emission sound pressure level of the enclosure in the calibration direction.

8. The method according to claim 3, wherein an enclosure incorporating the speaker of an audio channel comprises no UWB anchor, the calibration phase further comprising the steps of positioning the mobile apparatus in a close position in proximity to said enclosure, of implementing UWB geolocation in order to determine the close position, of equating the actual position of the enclosure to the close position, the estimate of the calibration distance and the estimate of the operational distance that are associated with said audio channel being produced by using the actual position of the enclosure.

9. The method according to claim 1, wherein the operational gains are updated only when the mobile apparatus has experienced a movement greater than a predetermined threshold with respect to its preceding current position.

10. The method according to claim 1, wherein the acquisition phase comprises the step of acquiring a phase difference in order to produce an immersive sound in the calibration position, and wherein the operational phase comprises the step of calculating, according to the current position, a delay applied to the immersive sound.

11. The method according to claim 1, wherein the calibration gains and/or the emission sound pressure levels of the enclosures in the calibration directions, which are used in the operational phase to define the operational gains, are dependent on a frequency of an acoustic signal broadcast in the operational phase by the audio channels.

12. Apparatus comprising a processing component in which the balancing method according to claim 1 is implemented.

13. The apparatus according to claim 12, wherein the apparatus is a smartphone.

14. The apparatus according to claim 12, wherein the apparatus is a connected enclosure.

15. A computer program comprising instructions which result in apparatus comprising a processing component the apparatus executing the steps of the balancing method according to claim 1.

16. A computer-readable storage medium, on which the computer program according to claim 15 is stored.
